(19) United States
(12) Patent Application Publication
(10) Pub. No.: US 2024/0208085 A1
(43) Pub. Date: Jun. 27, 2024

(54) DRIVING APPARATUS AND OPERATION METHOD THEREOF

(71) Applicant: SEMES CO., LTD., Chungcheongnam-do (KR)

(72) Inventors: Seung Chan LEE, Chungcheongnam-do (KR); Sun Oh KIM, Chungcheongnam-do (KR); Jeong Woo HAN, Chungcheongnam-do (KR); Ho Young LEE, Chungcheongnam-do (KR); Wang Hyeon SON, Chungcheongnam-do (KR); Woo Sang KWON, Chungcheongnam-do (KR); Dong Hoon YANG, Chungcheongnam-do (KR); Seung Seok HA, Chungcheongnam-do (KR); Seung Jun LEE, Chungcheongnam-do (KR); Gil Do KIM, Chungcheongnam-do (KR); Sang Hoon BAEK, Chungcheongnam-do (KR); Ji Wook KWON, Chungcheongnam-do (KR)

(21) Appl. No.: 18/373,869

(22) Filed: Sep. 27, 2023

(30) Foreign Application Priority Data
Dec. 22, 2022 (KR) 10-2022-0181442

(51) Int. Cl. B25J 21/00; F24F 3/167

(52) U.S. Cl. CPC B25J 21/005; F24F 3/167

(57) ABSTRACT

Provided are a driving apparatus and an operation method thereof. The driving apparatus includes driving parts driving on a driving path in a clean room in an autonomous driving manner, and handling parts provided on the driving parts and performing a three-dimensional handling operation for an object through flow in multi-directions.

### CROSS-REFERENCE TO RELATED APPLICATION

This application claims priority from Korean Patent Application No. 10-2022-0181442 filed on Dec. 22, 2022 in the Korean Intellectual Property Office, and all the benefits accruing therefrom under 35 U.S.C. 119, the contents of which in its entirety are herein incorporated by reference.

### BACKGROUND

### 1. Technical Field

The present disclosure relates to a driving apparatus and an operation method thereof.

### 2. Description of the Related Art

As robot technology develops, transportation based on autonomous driving is being performed. An autonomous driving robot in this regard is driven in various driving paths. Such a driving robot is intended to handle various objects (e.g., substrates, probe cards, etc.) within a line according to driving. Such a driving robot simply performs only loading and transporting of objects, but efficient handling of objects and an operation thereof are insufficient.

### RELATED ART DOCUMENT

### Patent Document

(Patent Document 1) Korean Patent Laid-Open Publication No. 10-2022-0104387

### SUMMARY

Aspects of the present disclosure are to ensure that a driving apparatus accurately and safely acquires and loads objects in the course of traveling from a starting point to a destination.

Aspects of the present disclosure are also to suppress human accidents and product damage that may occur when a worker manually handles a handling object with a relatively heavy load.

Aspects of the present disclosure are also to prevent a work load generated as a worker repeatedly handles a handling object and a decrease in uniformity of workability due to such a work load.

Aspects of the present disclosure are also to enable pre- and post-management so that the object is appropriately positioned within a preset range in acquiring and loading the handling object.

Aspects of the present disclosure are also to prevent an occurrence of abnormalities in a function test and a subsequent process due to a departure of an object from a preset correct position state through such pre- and post-management.

Aspects of the present disclosure are not limited to the above-mentioned aspects. That is, other aspects that are not mentioned may be obviously understood by those skilled in the art from the following specification.

According to an aspect of the present disclosure, there is provided a driving apparatus including: driving parts driving on a driving path in a clean room in an autonomous driving manner; and handling parts provided on the driving parts and performing a three-dimensional handling operation for an object through flow in multi-directions.

According to another aspect of the present disclosure, there is provided a driving apparatus including: driving parts driving on a driving path in a clean room in an autonomous driving manner; and handling parts provided on the driving parts and performing a three-dimensional handling operation for an object through flow in multi-directions, wherein the handling parts include: a first holding unit positioned above the driving parts and for holding the object, and a pickup unit positioned above the driving parts and handling the object to insert into or remove from the first holding unit, the pickup unit includes: a vertical variable module performing a first operation of being varied in a vertical direction, a forward/backward variable module performing a second operation of being varied in a forward/backward direction in the vertical variable module, and a contact module positioned in the forward/backward variable module and performing a third operation of picking up and acquiring the object by being in contact with the object, the contact module performs a fourth operation of being varied in a horizontal circumferential direction in the forward/backward variable module, the first holding unit performs a fifth operation of being varied in a direction crossing the forward/backward variable module, and the first holding unit includes: a first holding module on which the object is seated, and a fixing module installed on a circumferential portion of the first holding module to contact and fix a circumferential portion of the object positioned in the first holding module.

According to still another aspect of the present disclosure, there is provided an operation method of a driving apparatus, the operation method includes: driving driving parts of the driving apparatus on a driving path in a clean room in an autonomous driving manner, wherein the driving apparatus includes handling parts provided on the driving parts and performing a three-dimensional handling operation for an object through flow in multi-directions.

According to the driving apparatus and the operation method thereof of the present disclosure as described above, there are one or more of the following effects.

According to the present disclosure, the driving apparatus may accurately and safely acquire and load the objects in the course of traveling from the starting point to the destination.

In addition, it is possible to suppress human accidents and product damage that may occur when the worker manually handles an object with a relatively heavy load.

In addition, it is possible to prevent the work load generated as the worker repeatedly handles the handling object and a decrease in uniformity of workability due to such a work load.

In addition, it is possible to enable pre- and post-management so that the object is appropriately positioned within a preset range in acquiring and loading the handling object.

In addition, it is possible to prevent an occurrence of abnormalities in a function test and a subsequent process due to a departure of the object from a preset correct position through such pre- and post-management.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is a block diagram illustrating components of a driving apparatus according to an exemplary embodiment of the present disclosure;

FIG. 2 is a block diagram illustrating the components of the driving apparatus according to FIG. 1 in detail;

FIG. 3 is a block diagram illustrating the components of the driving apparatus according to FIG. 2 in detail;

FIG. 4 is a perspective view illustrating the components according to FIG. 1;

FIGS. 5 to 7 are views illustrating a handling state of an object through the components according to FIG. 1;

FIGS. 8 to 13 are views illustrating a state in which an object is grasped through the components according to FIG. 1;

FIGS. 14 to 17 are views illustrating an example of a process of loading an object of the driving apparatus according to FIG. 1;

FIGS. 18 to 20 are views illustrating an example of a process of collecting an object of the driving apparatus according to FIG. 1; and

FIG. 21 is a flowchart sequentially illustrating an operation method of a driving apparatus according to an exemplary embodiment of the present disclosure.

### DETAILED DESCRIPTION OF THE EMBODIMENTS

Hereinafter, exemplary embodiments of the present disclosure will be described in detail with reference to the accompanying drawings. Advantages and features of the present disclosure, and a method for achieving the advantages and features will become apparent with reference to the exemplary embodiments described below in detail in conjunction with the accompanying drawings. However, the present disclosure is not limited to the exemplary embodiments disclosed below, but may be implemented in a variety of different forms, these exemplary embodiments will be provided only in order to make the present disclosure complete and allow those skilled in the art to completely recognize the scope of the present disclosure, and the present disclosure is only defined by the scope of the claims. The same reference numbers indicate the same components throughout the specification.

Spatially relative terms “below”, “beneath”, “lower”, “above”, “upper”, and the like, may be used to easily describe correlations between one target or components and another target or components as illustrated in the drawings. The spatially relative terms are to be understood as terms including different directions of the targets at the time of use or operation in addition to directions illustrated in the drawings. For example, when a target illustrated in the drawing is turned over, a target described as being ‘below or beneath’ another target may be located ‘above’ another target. Therefore, an exemplary term ‘below’ may include both of directions of below and above. The target may also be oriented in other orientations, and thus spatially relative terms may be interpreted according to the orientation.

The terms “first”, “second” and the like are used to describe various targets, components, and/or sections but these targets, components, and/or sections are not limited by these terms. These terms are used only in order to distinguish one target, component, or section from another target, component, or section. Accordingly, a first target, a first component, or a first section mentioned below may also be a second target, a second component, or a second section within the spirit of the present disclosure.

The terms used herein are for the purpose of describing the exemplary embodiments and are not intended to limit the present disclosure. In the present specification, a singular form includes a plural form unless explicitly stated otherwise. Components, steps, operations, and/or targets mentioned by terms “comprise” and/or “comprising” used in the present disclosure do not exclude the existence or addition of one or more other components, steps, operations, and/or targets. Unless defined otherwise, all terms (including technical and scientific terms) used in the present specification have the same meaning as meanings commonly understood by those skilled in the art to which the present disclosure pertains.

In addition, terms defined in generally used dictionaries are not ideally or excessively interpreted unless specifically defined clearly.

Hereinafter, exemplary embodiments of the present disclosure will be described in detail with reference to the accompanying drawings. In describing the exemplary embodiments of the present disclosure with reference to the accompanying drawings, components that are the same as or correspond to each other will be denoted by the same reference numerals, and an overlapping description thereof will be omitted.

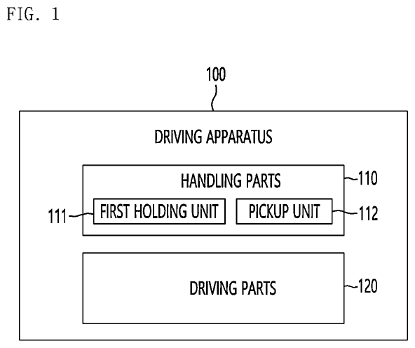

Referring to FIG. 1, a driving apparatus 100 according to an exemplary embodiment of the present disclosure includes handling parts 110 and driving parts 120. The handling parts 110 include a first holding unit 111 and a pickup unit 112.

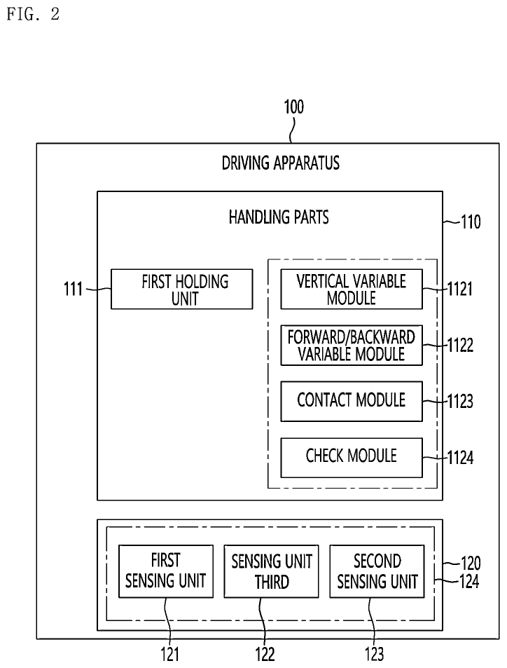

Further, referring to FIG. 2, the pickup unit 112 includes a vertical variable module 1121, a forward/backward variable module 1122, a contact module 1123, and a check module 1124. The driving parts 120 include a first sensing unit 121, a second sensing unit 123, a third sensing unit 122, and a driving unit 124.

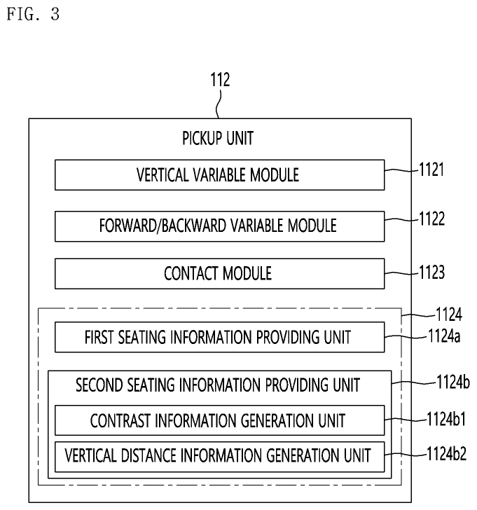

Referring to FIG. 3, the check module 1124 includes a first seating information providing unit 1124a and a second seating information providing unit 1124b. The second seating information providing unit 1124b includes a contrast information generation unit 1124b1 and a vertical distance information generation unit 1124b2.

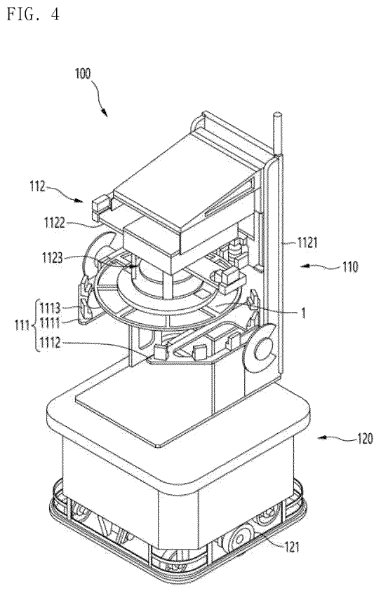

Further, referring to FIG. 4, the first holding unit 111 includes a first seating module 1111, a second seating module 1112, and a fixing module 1113. The driving parts 120 of the driving apparatus 100 drive on a driving path in a clean room in an autonomous driving manner. The handling parts of the driving apparatus 100 are provided above the driving parts 120 and the like.

The driving parts 120 perform a three-dimensional handling operation for the object 1 through flow in multi-axial directions. The first holding unit 111 of the handling parts 110 is positioned above the driving parts 120 and serves to hold the object 1.

The pickup unit 112 of the handling parts 110 is positioned above the driving parts 120. The pickup unit 112 handles the object 1 and serves to insert or remove the object 1 into or from the first holding unit 111.

Further, the vertical variable module 1121 of the pickup unit 112 performs a first operation of being varied in a vertical direction. The forward/backward variable module 1122 of the pickup unit 112 performs a second operation of being varied in a forward/backward direction in the vertical variable module 1121.

The contact module 1123 of the pickup unit 112 is positioned on the forward/backward variable module 1122. The contact module 1123 performs a third operation of being in contact with the object 1 to pick up and acquire the object 1.

The contact module 1123 performs a fourth operation of being varied in a horizontal circumferential direction in the forward/backward variable module 1122. The first holding unit 111 performs a fifth operation of being varied in a direction crossing with the forward/backward variable module 1122.

The object 1 is seated on the first holding module of the first holding unit 111. The fixing module 1113 of the first holding unit 111 is provided on a circumferential portion of the first holding module. The fixing module may fix the object 1 by being in contact with a circumferential portion of the object 1 positioned on the first holding unit 111.

Further, the first seating module 1111 of the first holding unit 111 is provided on one side of the object 1. The second seating module 1112 of the first holding unit 111 is provided on the other side of the object 1 to sandwich the object 1 together with the first seating module 1111.

The first seating module 1111 and the second seating module 1112 may operate in a first seating mode, a second seating mode, or the like. Here, the first seating mode refers to a state in which the object 1 is seated in a fixed state without variable operation of the first seating module 1111 and the second seating module 1112.

Further, the second seating mode refers to a state in which the first seating module 1111 and the second seating module 1112 are variably operated so as to be close to or separated from each other. That is, before the object 1 is seated, the first seating module 1111 and the second seating module 1112 are close to or separated from each other.

In the second seating mode, it is also possible that the first seating module 1111 and the second seating module 1112 are close to each other so as to correspond to the outside of the object 1 after the object 1 is seated. According to the variable operation of the first seating module 1111 and the second seating module 1112, the fixing module 1113 may be fixed by being in contact with the circumferential portion of the object 1.

The object 1 is moved between a first position corresponding to a starting position, a second position corresponding to the first holding unit 111, and a third position corresponding to the second holding unit 211 positioned at a destination.

Referring to FIGS. 3 to 5, the second seating information providing unit 1124b of the pickup unit 112 checks position information on a position of the object 1 in order to acquire and seat the object 1.

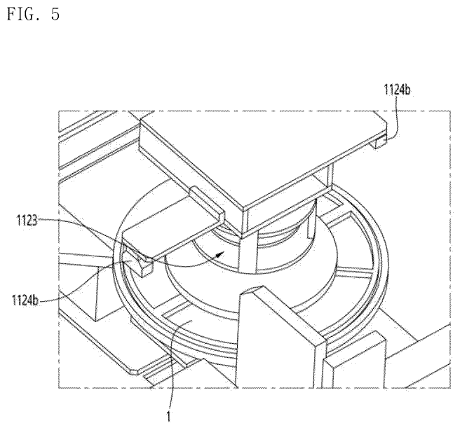

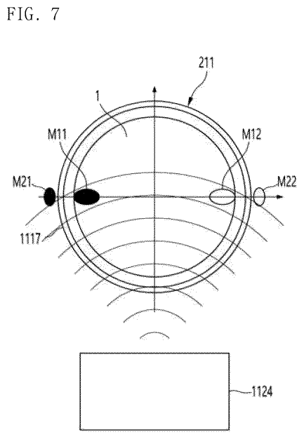

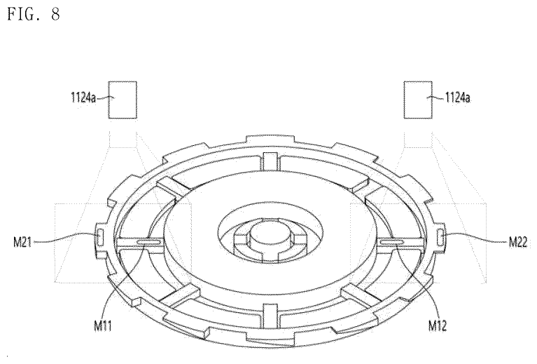

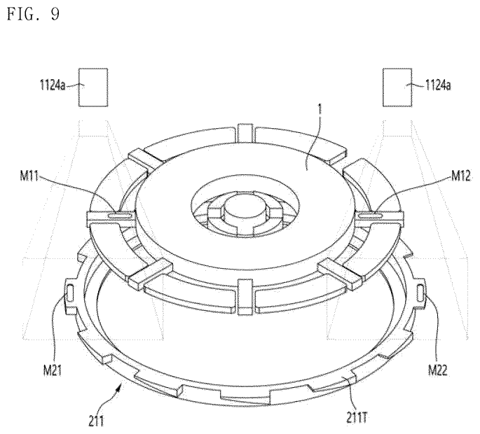

Referring to FIGS. 5 to 9, the object 1 is provided with a first main identification unit M11 and a second main identification unit M12. The second holding unit 211 is provided with a first sub-identification unit M21 corresponding to the first main identification unit M11 and a second sub-identification unit M22 corresponding to the second main identification unit M12.

Here, the first seating information providing unit 1124a of the check module 1124 checks the arrangement state of the first main identification unit M11 and the second main identification unit M12 based on the first sub-identification unit M21 and the second sub-identification unit M22.

The first seating information providing unit 1124a of the check module 1124 provides first seating suitability information on suitability for seating the object 1 in a correct position on the second holding unit 211 by checking the arrangement state of the first main identification unit M11 and the second main identification unit M12.

Here, the contact module 1123 of the pickup unit 112 allows the object 1 to be seated in a correct position based on the first seating suitability information. The object 1 includes a probe card. The second holding unit 211 includes a seating unit provided on a probe station.

This is illustrative, and the object 1 is not limited to the probe card. Likewise, the second holding unit 211 is not limited to the probe station.

The first seating information providing unit 1124a detects whether or not there is an object previously loaded on the second holding unit 211 before the object 1 is seated. The first seating information providing unit 1124a allows the object 1 to be seated when the load does not exist through the detection of whether the load exists or not.

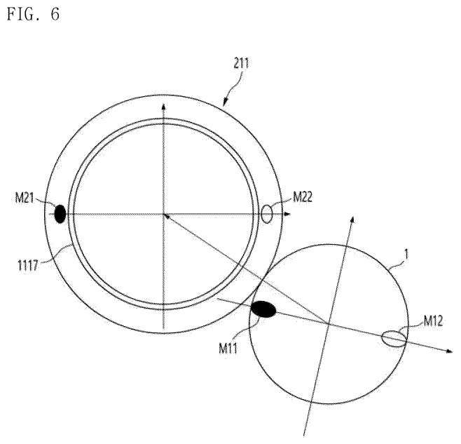

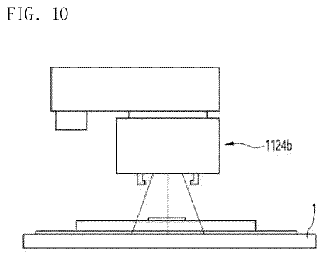

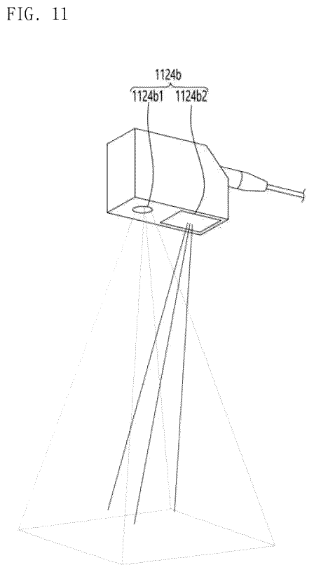

Referring to FIGS. 6 and 7 and 10 and 11, the second holding unit 211 is provided with a circumferential portion 211T accommodating the object 1 therein. Here, the second seating information providing unit 1124b of the check module 1124 provides second seating suitability information on whether a seating state of the object 1 meets a preset standard, after the object 1 is seated on the second holding unit 211.

Further, the contrast information generation unit 1124b1 of the second seating information providing unit 1124b compares the state of the object 1 seated and accommodated in the second holding unit 211 with the circumferential portion 211T, and generates contrast information.

The vertical distance information generation unit 1124b2 of the second seating information providing unit 1124b pre-multiplies descending and ascending distances for acquiring or loading the object 1 from the second holding unit 211, and generates vertical distance information on the descending and ascending distances.

The second seating information providing unit 1124b provides the second seating suitability information on the basis of the contrast information and the vertical distance information. The second seating information providing unit 1124b generates the second seating suitability information by sequentially or non-sequentially combining the contrast information and the vertical distance information.

Here, the contrast information is generated based on a step difference between the object 1 and the circumferential portion 211T in a state in which the object 1 is seated. The contact module 1123 operates in a first mode in which the object 1 positioned on the first holding unit 111 is in contact with and fixed to the upper portion in the process of driving along the driving path.

The vertical variable module 1121 operates in a second mode in which the object 1 flows upward in a state in which the object 1 is mounted on the contact module 1123. The forward/backward variable module 1122 operates in a third mode of protruding from the vertical variable module 1121 after the second mode.

Further, the vertical variable module 1121 operates in a fourth mode that is induced downward after the third mode. The object 1 is transferred from the first holding unit 111 to the second holding unit 211 based on the first to fourth modes.

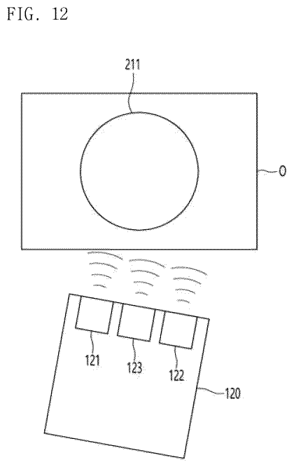

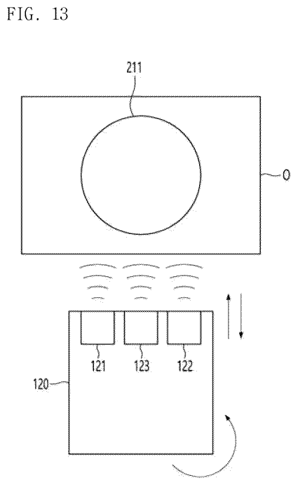

Referring to FIGS. 3, 12, and 13, the driving unit 124 of the driving parts 120 performs an operation for driving the driving apparatus 100. The first sensing unit 121 of the driving parts 120 is provided in the driving unit 124 to handle the object 1.

The first sensing unit 121 generates first separation information by detecting separation distance coordinate information in a theta direction for a first area of a holding object O (e.g., the second holding unit 211 or the probe station, which is an object provided with the second holding unit 211, etc.) where the object 1 is positioned.

The second sensing unit 123 of the driving parts 120 is provided in the driving unit 124 to handle the object 1. The second sensing unit 123 generates second separation information by detecting separation distance coordinate information in a theta direction for a second area of the holding object O where the object 1 is positioned.

In this case, the second area of the holding object O includes areas positioned side by side with the first area on the left and right. The driving unit 124 performs a first correcting operation and a handling operation.

The first correcting operation is to correct a displaced state relative to the holding object O based on the first and second separation information. Here, the handling operation is to perform the handling operation of the handling parts 110 by performing separation distance adjustment for the holding object O.

Meanwhile, the third sensing unit 122 of the driving parts 120 detects a separation distance from the holding object O and generates third separation information. The driving unit 124 allows the handling operation of the handling parts 110 to be performed by performing a second correcting operation for performing separation distance adjustment for the holding object O based on the third separation information.

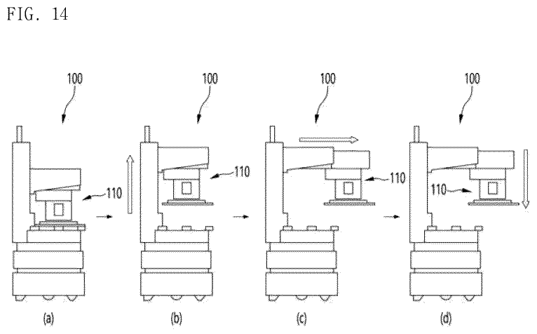

Examples of loading scenarios of the object 1 will be described with reference to FIGS. 14 to 17. Referring to FIG. 14, the pickup unit 112 picks up the object 1 and performs ascending, forward movement, and descending operations.

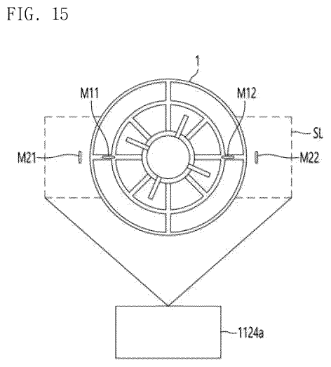

Referring to FIG. 15, the first seating information providing unit 1124a then checks the arrangement state of the first main identification unit M11 and the second main identification unit M12 based on the first sub-identification unit M21 and the second sub-identification unit M22 described above.

Through this, the first seating information providing unit 1124a provides first seating suitability information on suitability for seating the object 1 in a correct position on the second holding unit 211.

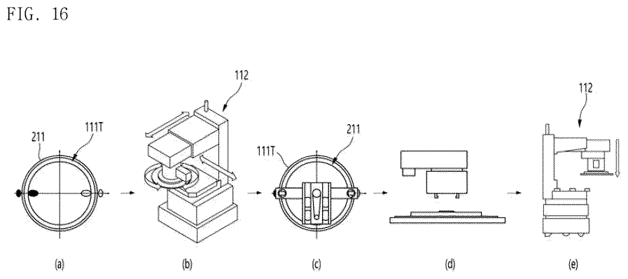

Referring to FIG. 16, after this, a correction value is calculated based on the first seating suitability information, and at least the first operation, the second operation, and the fourth operation are performed. Subsequently, an alignment of the object 1 and the second holding unit 211 according to at least the first operation, the second operation, and the fourth operation is finally confirmed.

Further, the first seating information providing unit 1124a senses a distance between the object 1 and the second holding unit 211. Subsequently, the pickup unit 112 descends to a corresponding position to be moved.

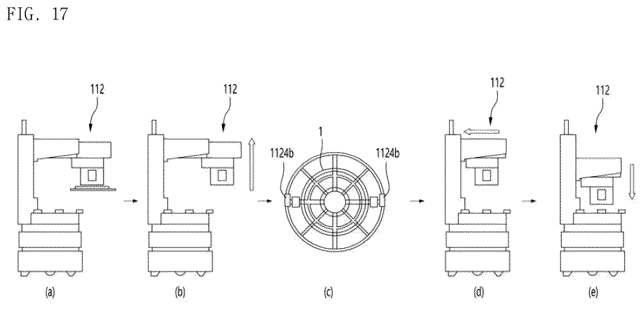

Referring to FIG. 17, the pickup unit 112 performs an ascending operation after loading the object 1. In this case, the second seating information providing unit 1124b compares a circumference of the object 1 seated on the second holding unit 211 with the circumferential portion 211T of the second holding unit 211 (e.g., confirms a step difference therebetween), and checks whether the object 1 is accommodated and positioned in the correct position (e.g., appropriate depth, etc.). Then, the pickup unit 112 returns to an original position through backward movement and descending.

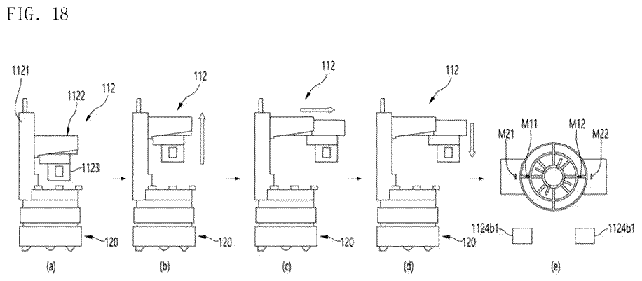

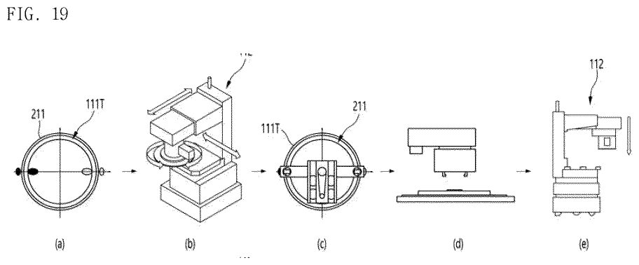

Hereinafter, examples of collection scenarios for the object 1 of the pickup unit 112 will be described with reference to FIGS. 18 to 20. Referring to FIG. 18, the pickup unit performs an ascending operation, a forward movement operation, and a descending operation in order to collect the object 1.

Further, the first seating information providing unit 1124a checks the arrangement state of the first main identification unit M11 and the second main identification unit M12 based on the first sub-identification unit M21 and the second sub-identification unit M22 described above.

Through this, the pickup unit 112 that has acquired the object 1 calculates a correction value for the object 1 and performs an alignment operation to align to a position corresponding to the object 1.

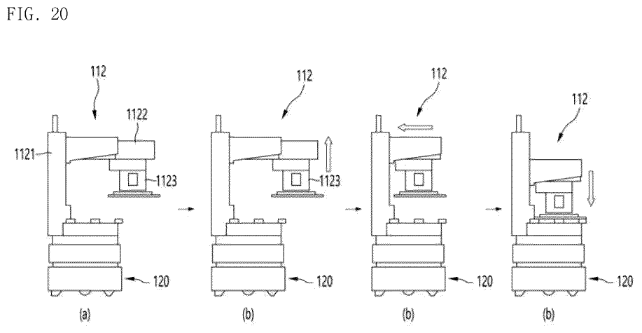

After the final confirmation of the alignment operation, a descending operation towards the object 1 is performed based on the operation of the second seating information providing unit 1124b. Referring to FIG. 20, the pickup unit 112 collects the object 1 and ascends. In addition, the pickup unit 112 returns to an original position through backward movement and descending operations.

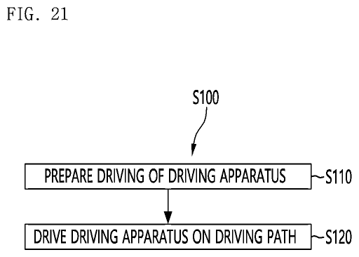

Referring to FIG. 21, in an operation method S100 of a driving apparatus, first, a driving apparatus 100 driving to handle an object 1 is prepared. Further, the driving parts 120 of the driving apparatus 100 drive on a driving path in a clean room in an autonomous driving manner.

Based on such driving, pickup and loading of the object 1 may be repeatedly performed. Here, the driving apparatus 100 is provided on the driving parts 120, and performs a three-dimensional handling operation for the object 1 through flow in multi-axial directions.

Although the exemplary embodiments of the present disclosure have been described with reference to the accompanying drawings, those of ordinary skill in the art to which the present disclosure pertains will understand that the present disclosure may be embodied in other specific forms without changing the technical spirit or essential features thereof. Therefore, it is to be understood that the exemplary embodiments described above are illustrative rather than being restrictive in all aspects.

What is claimed is:

1. A driving apparatus comprising:
driving parts driving on a driving path in a clean room in an autonomous driving manner; and
handling parts provided on the driving parts and performing a three-dimensional handling operation for an object through flow in multi-directions.

2. The driving apparatus of claim 1, wherein the handling parts include:
a first holding unit positioned above the driving parts and for holding the object, and
a pickup unit positioned above the driving parts and handling the object to insert into or remove from the first holding unit.

3. The driving apparatus of claim 2, wherein the pickup unit includes:
a vertical variable module performing a first operation of being varied in a vertical direction,
a forward/backward variable module performing a second operation of being varied in a forward/backward direction in the vertical variable module, and
a contact module positioned in the forward/backward variable module and performing a third operation of picking up and acquiring the object by being in contact with the object.

4. The driving apparatus of claim 3, wherein the contact module performs a fourth operation of being varied in a horizontal circumferential direction in the forward/backward variable module, and
the first holding unit performs a fifth operation of being varied in a direction crossing the forward/backward variable module.

5. The driving apparatus of claim 3, wherein the first holding unit includes:
a first holding module on which the object is seated, and
a fixing module installed on a circumferential portion of the first holding module to contact and fix a circumferential portion of the object positioned in the first holding module.

6. The driving apparatus of claim 5, wherein the first holding module includes:
a first seating module provided on one side of the object, and
a second seating module provided on the other side of the object to sandwich the object together with the first seating module,
the first seating module and the second seating module is operable in any one of:
a first seating mode in which the object is seated in a fixed state, and
a second seating mode in which the object is seated in a variable operating state so that the first seating module and the second seating module are close to or separated from each other, and
the fixing module is in contact with and fixed to the circumferential portion of the object according to the variable operation of the first seating module and the second seating module.

7. The driving apparatus of claim 6, wherein the driving parts include:
a driving unit performing an operation for driving,
a first sensing unit generating first separation information by detecting separation distance coordinate information in a theta direction for a first area of a holding object where the object is positioned, in handling the object, and
a second sensing unit generating second separation information by detecting separation distance coordinate information in a theta direction for a second area of the holding object where the object is positioned, in handling the object,
the second area of the holding object includes areas positioned side by side with the first area on the left and right, and
the driving unit allows the handling operation to be performed by performing a first correction operation of correcting a displaced state relative to the holding object based on the first separation information and the second separation information, and separation distance adjustment for the holding object.

8. The driving apparatus of claim 7, wherein the driving parts further include a third sensing unit detecting a separation distance from the holding object and generating third separation information, and
the driving unit allows the handling operation of the handling parts to be performed by performing a second correction operation of performing separation distance adjustment for the holding object based on the third separation information.

9. The driving apparatus of claim 5, wherein the contact module operates in a first mode in which the object positioned on the first holding unit is in contact with and fixed to an upper portion in a process of driving along the driving path.

10. The driving apparatus of claim 9, wherein the vertical variable module operates in a second mode in which the object flows upward in a state in which the object is mounted on the contact module,
the forward/backward variable module operates in a third mode of protruding from the vertical variable module after the second mode,
the vertical variable module operates in a fourth mode that is induced downward after the third mode, and
the object is transferred from the first holding unit 111 to a second holding unit different from the first holding unit based on the first to fourth modes.

11. The driving apparatus of claim 3, wherein the object is moved between a first position corresponding to a starting position, a second position corresponding to the first holding unit, and a third position corresponding to the second holding unit positioned at a destination.

12. The driving apparatus of claim 11, wherein the pickup unit further includes a check module checking position information of the object for acquisition and seating of the object.

13. The driving apparatus of claim 12, wherein the object is provided with a first main identification unit and a second main identification unit,
the second holding unit is provided with a first sub-identification unit corresponding to the first main identification unit and a second sub-identification unit corresponding to the second main identification unit,
the check module includes a first seating information providing unit providing first seating suitability information on suitability for seating the object in a correct position on the second holding unit by checking an arrangement state of the first main identification unit and the second main identification unit based on the first sub-identification unit and the second sub-identification unit, and
the pickup unit allows the object to be seated in a correct position based on the first seating suitability information.

14. The driving apparatus of claim 13, wherein the object includes a probe card, and the second holding unit includes a seating unit on which the object is seated on a probe station.

15. The driving apparatus of claim 14, wherein the first seating information providing unit detects whether or not there is an object previously loaded on the first holding unit or the second holding unit before the object is seated and allows the object to be seated when the load does not exist.

16. The driving apparatus of claim 12, wherein the second mounting unit has a circumferential portion for accommodating the object therein, and
the check module further includes a second seating information providing unit providing second seating suitability information on whether a seating state of the object meets a preset standard, after the object is seated on the second holding unit.

17. The driving apparatus of claim 16, wherein the second seating information providing unit includes:
a contrast information generation unit comparing the state of the object seated and accommodated in any one of the first holding unit and the second holding unit with the circumferential portion and generating contrast information, and
a vertical distance information generation unit generating vertical distance information on descending and ascending distances for acquiring the object from the first holding unit or the second holding unit 211, and
the second seating information providing unit provides the second seating suitability information based on the contrast information and the vertical distance information.

18. The driving apparatus of claim 17, wherein the second seating information providing unit generates the second seating suitability information by sequentially or non-sequentially combining the contrast information and the vertical distance information, and
the contrast information is generated based on a step difference between the object and the circumferential portion in a state in which the object is seated.

19. A driving apparatus comprising:
driving parts driving on a driving path in a clean room in an autonomous driving manner; and
handling parts provided on the driving parts and performing a three-dimensional handling operation for an object through flow in multi-directions,
wherein the handling parts include a first holding unit positioned above the driving parts and for holding the object, and a pickup unit positioned above the driving parts and handling the object to insert into or remove from the first holding unit,
the pickup unit further includes a vertical variable module performing a first operation of being varied in a vertical direction, a forward/backward variable module performing a second operation of being varied in a forward/backward direction in the vertical variable module, and a contact module positioned in the forward/backward variable module and performing a third operation of picking up and acquiring the object by being in contact with the object,
the contact module performs a fourth operation of being varied in a horizontal circumferential direction in the forward/backward variable module,
the first holding unit performs a fifth operation of being varied in a direction crossing the forward/backward variable module, and
the first holding unit includes a first holding module on which the object is seated, and a fixing module installed on a circumferential portion of the first holding module to contact and fix a circumferential portion of the object positioned in the first holding module.

20. An operation method of a driving apparatus, the operation method comprising:
driving driving parts of the driving apparatus on a driving path in a clean room in an autonomous driving manner,
wherein the driving apparatus includes handling parts provided on the driving parts and performing a three-dimensional handling operation for an object through flow in multi-directions.
